(19) United States
(12) Patent Application Publication
(10) Pub. No.: US 2015/0107915 A1
(43) Pub. Date: Apr. 23, 2015

(54) Vacuum Stepper Robot

(71) Applicant: AREVA Inc., Lynchburg, VA (US)

(72) Inventors: S. William Glass, III, Lynchburg, VA (US); Bradley A. Thigpen, Harrisburg, NC (US); Robert A. Furter, Lynchburg, VA (US)

(21) Appl. No.: 14/519,169

(22) Filed: Oct. 21, 2014

Related U.S. Application Data
(60) Provisional application No. 61/893,669, filed on Oct. 21, 2013.

(51) Int. Cl. B62D 57/032

(52) U.S. Cl. CPC B62D 57/032; Y10S 901/01; Y10S 901/44; Y10S 901/46; Y10S 901/47
USPC 180/8.6; 901/1; 901/44; 901/46; 901/47

(57) ABSTRACT

A low profile stepper robot is described and claimed herein. The robot includes a plurality of foot assemblies. Each foot assembly includes a suction cup, a vacuum generator, and a valve, with the vacuum generator being operationally connected to the suction cup. A conduit connects a source of operational fluid flow to the vacuum generators, and the valves allow or prevent fluid flow to the vacuum generators. Actuators are positioned between the foot assemblies and the robot base. The actuators provide for linear and rotational displacement of the foot assemblies, allowing the robot to walk and turn along an inspection surface.

### CROSS-REFERENCE TO RELATED APPLICATIONS

This patent application claims the benefit of U.S. Provisional Patent Application No. 61/893,669 filed on Oct. 21, 2013, which is incorporated herein by reference in its entirety.

### BACKGROUND OF THE INVENTION

1. Field of the Invention

The present invention relates to robot systems, and, more particularly, the present invention relates to a stepper robot having a vacuum-based foot assembly.

2. Description of the Related Art

Complex industrial plants typically include several systems each having numerous pieces of equipment. Periodic inspection of such equipment is frequently necessary to ensure safe operating conditions are maintained. Automated robotic crawling systems can be used to perform labor intensive and dangerous field inspections, and to effect any necessary repairs.

The complex nature of known robotic crawling systems coupled with their functionality requirements normally results in a relatively large robot system. Such size, however, can preclude operation of the robots in environments where equipment and/or structures do not allow for the clearance required by such known systems.

Thus, what is needed is a low-profile robotic inspection system.

### SUMMARY OF THE INVENTION

A low profile stepper robot is described and claimed herein. The robot includes a plurality of foot assemblies. Each foot assembly includes a suction cup, a vacuum generator, and a valve, with the vacuum generator being operationally connected to the suction cup. A conduit connects a source of operational fluid flow to the vacuum generators, and the valves allow or prevent fluid flow to the vacuum generators.

The foot assemblies are connected to a base of the robot. Actuators are positioned between the foot assemblies and the base. A first of the actuators is positioned so as to linearly displace one of the foot assemblies relative the base such that its suction cup can be moved, thereby allowing the robot to step or move along the inspection surface. A second of the actuators is positioned so as to rotationally displace one of the foot assemblies relative the base such that its suction cup can be rotated, thereby allowing the robot to turn along the inspection surface. By varying the attachment of this turning suction cup, the robot can be turned in either direction.

Optionally, additional actuators can be included to vertically displace the suction cups from the base, thereby allowing the robot to be raised from the inspection surface. This allows the robot to pass over obstacles that may be encountered on the inspection surface.

A pressure sensor is included with each foot assembly to ensure a vacuum is present prior to releasing the other foot assembly from the inspection surface. This ensures the robot does not become separated from the inspection surface.

### DESCRIPTION OF THE DRAWINGS

The present invention is described with reference to the accompanying drawings, which illustrate exemplary embodiments and in which like reference characters reference like elements. It is intended that the embodiments and figures disclosed herein are to be considered illustrative rather than restrictive.

FIG. 1 shows a bottom view of a robot of the present invention with array sensors and feet aligned and in a first walking position.

FIG. 2 shows a top view of a foot assembly of the robot assembly of FIG. 1.

FIG. 3 shows a side cross-sectional view of the foot assembly of FIG. 2.

FIG. 4 shows a bottom view of the robot assembly of FIG. 1 with array sensors and feet aligned and in second walking position.

FIG. 5 shows a bottom view of the robot assembly of FIG. 1 with feet actuated to a turning position.

FIG. 6 shows a bottom view of the robot assembly of FIG. 1 with a linear carriage attached to a walking base.

FIG. 7 shows a side cross-sectional view of the robot assembly of FIG. 1 including optional lifting components.

### DETAILED DESCRIPTION OF THE INVENTION

The inventive vacuum stepper robot is a low-profile walking robot for inspection of any relatively smooth surface material. Exemplary inspection sensors can include ultrasound or eddy current equipment, or video cameras for visual inspections. While a variety of applications are available, the robot is particularly suited for inspection and/or repair of carbon-fiber reinforced plastics used in aircrafts and wind-turbine blades, and for stainless steel piping where magnetically coupled crawlers cannot be used.

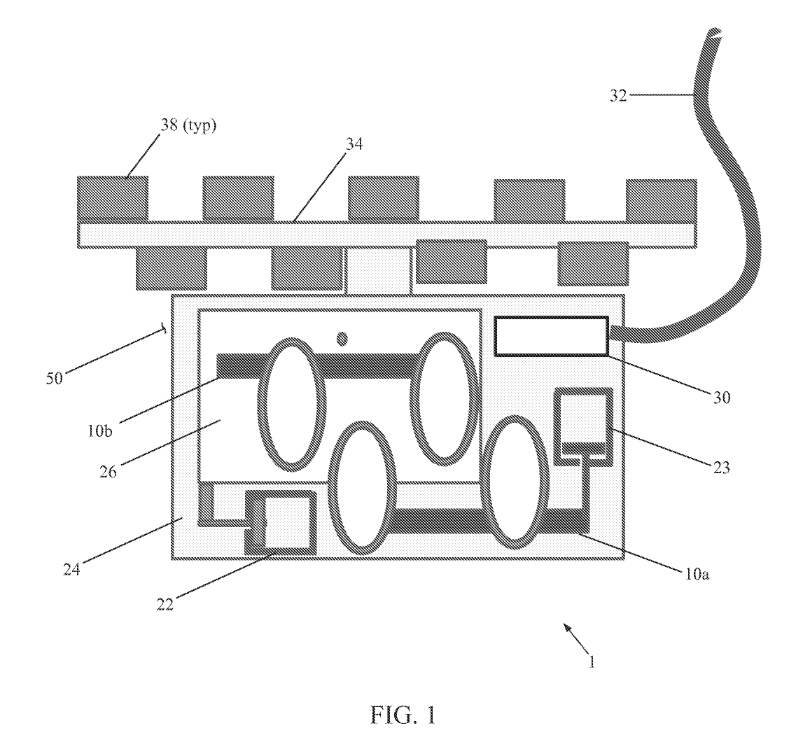

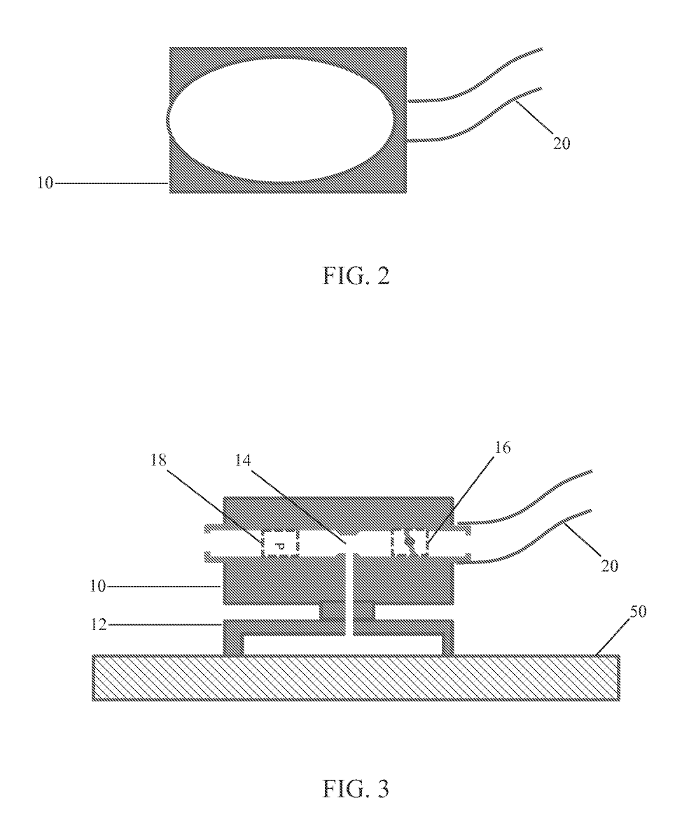

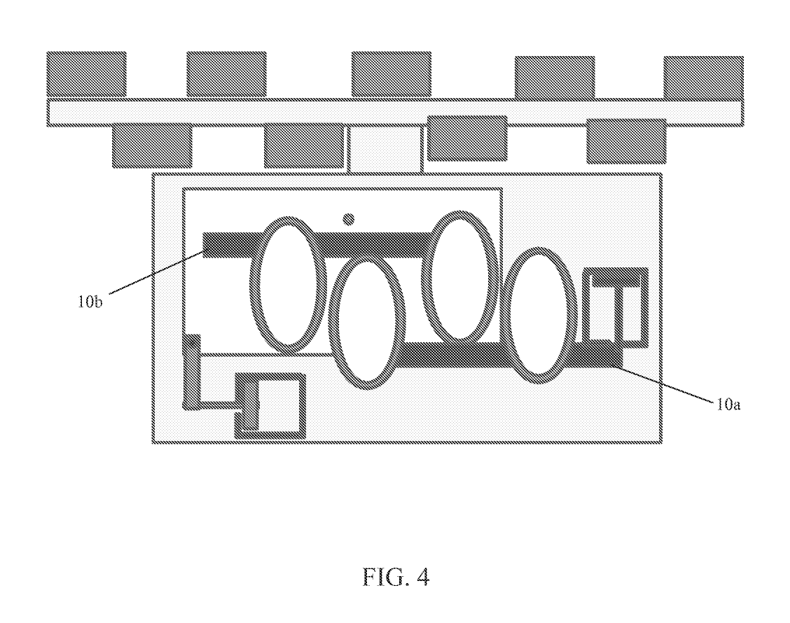

FIG. 1 shows a bottom view of a preferred embodiment of a robot 1 of the present invention, and FIGS. 2 and 3 show top and side cross-sectional views, respectively, of a foot assembly 10 of the robot 1. The robot 1 includes at least two vacuum foot assemblies 10. Each vacuum foot assembly 10 includes a gasketed suction cup 12, a vacuum generator 14, a valve 16, and a pressure sensor 18. The valve 16 preferably is a remotely actuated valve, and it may be positioned on the foot 10 or in a valve manifold on the base of the robot 1. When the valve 16 is open, operating fluid such as air or water flows through a flexible supply hose 20 to the nozzle 14. The vacuum generated within the throat of the nozzle 14 is ported to the suction cup 12, which is in contact with the walking or inspection surface 50. Once a vacuum is established, the pressure sensor 18 confirms the presence of a vacuum within the suction cup 12 in known manner. The vacuum is maintained as long as fluid flows through the nozzle 14, and the vacuum is released by shutting off the flow to the nozzle 14. The pressure sensor 18 preferably may be a switch that is closed in the presence of a vacuum from its default open position.

In a preferred embodiment, the vacuum generator 14 is based on a venturi nozzle 14. A venturi nozzle or tube includes an inlet, a convergent cone, a throat, and an optional divergent cone. As fluid flows through the convergent portion of the nozzle 14, the fluid velocity increases and at the same time its pressure decreases. In use, a vacuum is created within the suction cup 12 by porting the throat of the nozzle 14 thereto. A divergent zone can optionally be included downstream of the throat to reduce the overall pressure loss.

Preferably, the vacuum generator 14 provides a suction force of at least 25 pounds as measured in air. This should ensure the robot 1 remains connected to the surface 50 during operation. If additional suction force is required, the flow through the nozzle 14 can be increased. Alternatively or additionally, the surface area of the foot assemblies can be increased, either by including additional feet or increasing the size of the existing feet. While oval suction cups 12 are shown in the illustrated embodiments, any shape may be used.

The walking assembly 1 includes two or more vacuum foot assemblies 10 as illustrated in FIG. 1. The foot assemblies 10 are shown as two pairs of feet to distribute the load over a broader area. This is a preferred implementation, but is not necessary for the system 1 to perform the target stepping function. While not depicted in FIG. 1, it will be understood that the operational fluid flow provided by the hose 20 is connected to each foot assembly 10 by a separate valve 16, allowing each foot assembly 10 to be controlled independent of other foot assemblies 10.

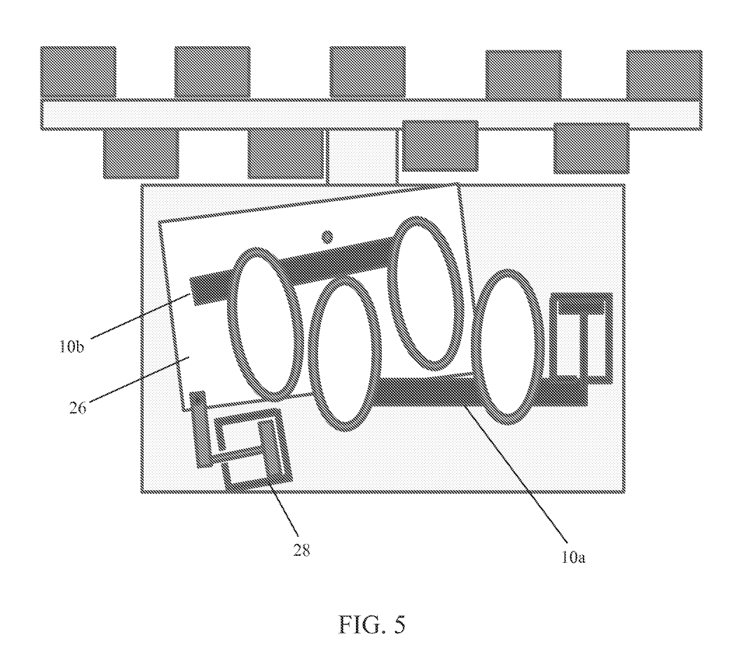

For purpose of explanation, the paired foot assemblies 10 will be designated as walking foot 10a and turning foot 10b. With its valve 16 open, turning foot 10b is adhered by suction to the walking surface 50 to initially attach the entire assembly 1 to the walking surface 50. The walking foot 10a with its valve 16 closed can then be advanced forward by an actuator 22 that pushes the foot assembly 10a several millimeters ahead of the robot base plate 24. The actuator 22 may preferably be an air cylinder. This is illustrated in FIG. 4. If the surface roughness is extreme, this advance of walking foot may be preceded by a lifting of the foot 10a and followed by a lowering of the foot 10a using a similar actuator 25 to the actuator 22 used to advance the foot. Once the walking foot 10a is in contact with the surface 50 at the desired advanced location, its valve 16 is opened to start the vacuum and suck the walking foot 10a to the surface 50. The presence of a vacuum in the walking foot 10a may be confirmed with the pressure sensor 18 prior to releasing the turning foot 10b so that the robot never releases the turning foot 10b until the walking foot 10a is confirmed to be connected to the surface 50. This precludes the robot 1 from falling due to the vacuum not being established.

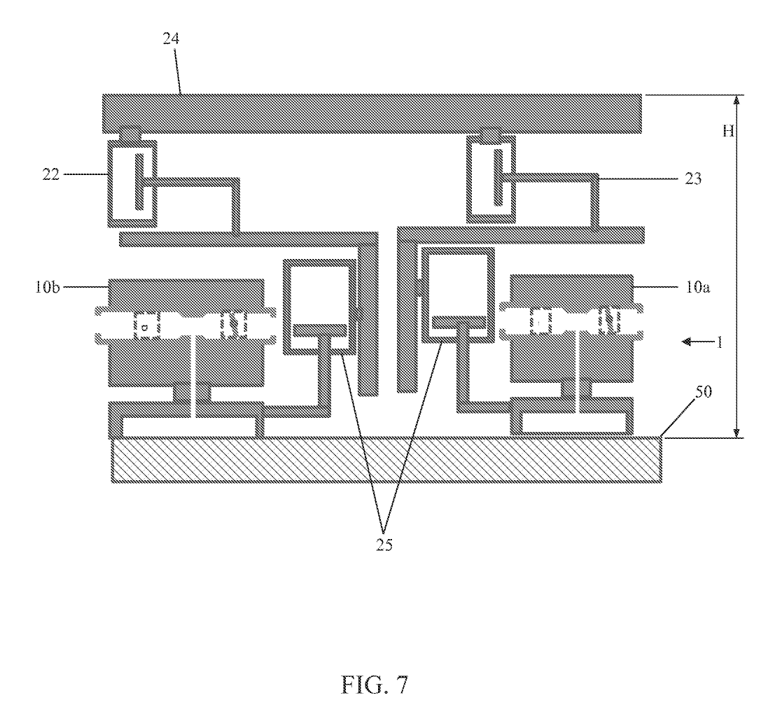

With walking foot 10a firmly attached to the surface 50, the turning foot 10b can be released by closing its valve 16. This allows the turning foot 10b to slide along the surface 50. If the surface 50 is rough, the same actuator discussed with walking foot 10a can lift and lower the turning foot assembly 10b. Alternatively, each foot assembly 10 can be provided with a separate lifting actuator 25 as illustrated in FIG. 7. The turning foot 10b as well as the rest of the robot assembly 1 is then advanced by the walking foot actuator 23 as it shifts state. The turning foot 10b valve 16 is then opened, thereby allowing the turning foot 10b to suck and adhere to the surface 50. Suction is confirmed by the pressure sensor 18. Controller logic preferably will not allow either foot 10a, 10b to release until vacuum suction (and therefore connection of the robot 1 to the surface 50) is confirmed in the other foot 10b, 10a. The walking step can then be repeated. Cycle times can be quite short (less than 1 or 2 seconds) because of the close proximity of the vacuum generators 14 to the suction feet 10a, 10b. The length of each step is repeatable and adjustable as the actuators 22 drive the walking foot assembly 10a to a hard-stop that can be adjusted from approximately 1 mm to more than 10 mm. The robot assembly 1 can travel in the circumferential direction, which is preferred for scanning a full pipe, or the axial direction.

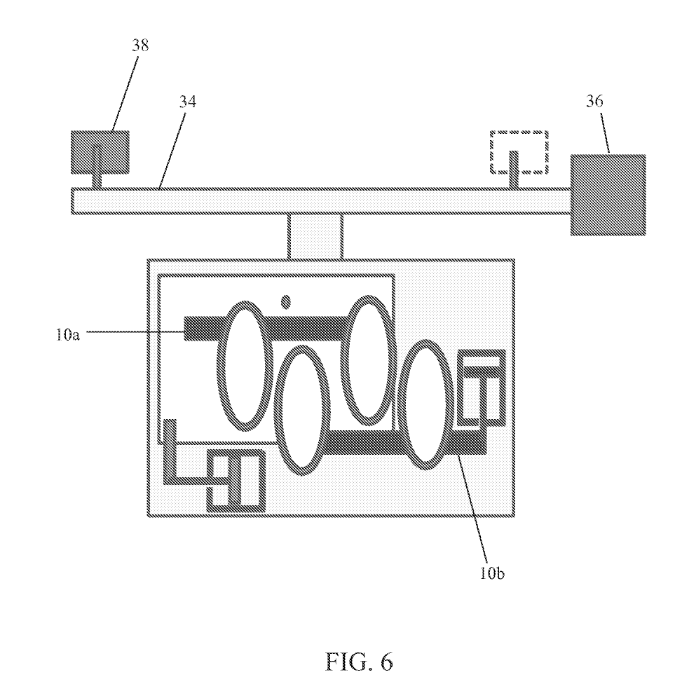

Steering of the assembly 1 is effected with a similar set of actuators to the walking actuators 22, 23. The turning feet 10b are mounted on a platen 26 that that can rotate from a first state of being aligned with the robot carriage (FIGS. 1 and 4) to a second state of being angled few degrees in one direction relative the robot carriage (FIG. 5). If the turning foot platen 26 is aligned with the robot carriage and correspondingly with the walking foot 10a, then the robot assembly 1 will walk in a straight line. If this straight line needs to be adjusted or steered, the turning platen actuator 28 is engaged. The assembly 1 may be turned one way by engaging the turning platen actuator 28 before the walking feet 10a are advanced; that is, with the turning foot 10b engaged with the surface 50. The assembly 1 can be turned the opposite way by rotating the turning foot 10b to the angled position while they are not engaged with the surface 50 and while they are being advanced by the walking feet actuator 22. This is illustrated in FIG. 5. After the turning foot 10b is re-engaged with the surface 50 and after the walking feet 10a are released from the surface 50, the turning foot 10b may return the turning foot platen 26 to be aligned with the robot assembly 1. This effectively rotates the assembly 1 in the other direction by the number of degrees allowed by the turning platen hard-stop.

Steering the robot 1 can be done either in an open loop simply relying on the known step distance and step turn degrees which are precisely set and controlled by an adjustable hard-stop, or with a closed loop independent position sensing system like a stereo vision position sensor or a laser tracker or an independent optical mouse encoder. Reference is made to commonly owned U.S. patent application Ser. Nos. 13/731,580 and 13/731,709, which are incorporated herein.

The valve manifold 30 is connected to a flexible umbilical and tether 32 that can be more than 30 meters long without compromising function. This allows the robot 1 to crawl out of direct view of an operator to inspect parts that are difficult to access. Normally if the umbilical will be used where there is a concern for losing the robot 1, the umbilical hoses and control wires would include a steel tether cable to pull the robot back to the operating station location.

A sensor arm 34 is connected to the main body of the robot 1 and can have several embodiments. For example, as shown in FIG. 6, a single sensor 38 can be used. If this is the case, the stepper must steer back and forth to cover an area wider than the sensor area covered. Alternatively, as illustrated in FIGS. 1-5, an array of sensors 38 can be used to cover a wide swath of material with each pass of the robot 1. Another example, a scanning arm can be used. Scanning arms typically contain a motor 36 attached to the arm 34 driving a belt or a lead-screw to translate a sensor 38 across the area to be examined.

The robot 1 is a low profile robot, allowing it to operate in environments with tight spacing such as industrial piping systems. In such systems, there may only be a few inches of space between system components, precluding the use of typical crawler systems. The robot 1 has a height H that preferably is 5 inches or less, and more preferably 3 inches or less. This height H is a measurement of the total height of the system, including all components. The foot assembly components (suction cup 12, vacuum generator 14, valve 16, and pressure sensor 18), actuators 22, and base plate 24 are chosen and positioned to minimize their combined height. The placement of these components is also chosen to minimize the height H. While the vacuum generator 14, valve 16, and pressure sensor 18 are shown in the figures as being vertically in line with the suction cup 12 for illustrate purposes, these components may preferably be positioned horizontally offset from (that is, not vertically aligned with) the suction cup 12. This placement allows the vacuum generator 14, valve 16, and pressure sensor 18 to be lowered and positioned more horizontally aligned with the suction cup 12 (but not impeding movement of the robot 1), further reducing the overall height of the robot 1. The overall height of the robot 1 is further minimized by attaching the sensor arm 34 to a side of the base plate 24 rather than the top surface thereof. The robot 1 also has a relatively small footprint, preferably 1 ft² or less and more preferably 10 in² or less. This footprint is an overall footprint, a measurement of the total surface area covered by the robot including all components. The low profile character of the robot 1 allows the robot 1 to operate with tight spacing between components. The small footprint, and particularly using closely spaced and relatively small vacuum feet, allows the robot to navigate surfaces having a small radius of curvature.

A prototype unit used four foot assembly having feet that are approximately 1.8 inches wide by 8 inches long. Allowing for the side-by-side spacing among the feet, this yields a compact total footprint that is approximately 8 in². The design must trade-off stability associated with wider spacing of the feet versus the need for a small overall footprint in order to move on small radius of curvature parts. The strong vacuum provides sufficient holding force to counteract side moments without expanding or spreading the feet beyond the compact square configuration.

The disclosed configuration can work on flat surfaces to surfaces having radii of curvatures of approximately 18 inches. Smaller radii of curvature can also be scanned if contoured feet are provided. The stepper robot can travel preferentially in the circumferential direction (preferred for scanning a full pipe) or axial direction. The reason the circumferential stepping is preferred is that this allows a full circumferential stepping run for scanning a circumferential weld. Axial motion to scan the transducer up to the weld or across the weld can be achieved via a low-profile linear scanner positioned on the front of the stepper platform or by a sufficient number of side-by-side transducers to cover the target inspection surface.

While the preferred embodiments of the present invention have been described above, it should be understood that they have been presented by way of example only, and not of limitation. It will be apparent to persons skilled in the relevant art that various changes in form and detail can be made therein without departing from the spirit and scope of the invention. Thus the present invention should not be limited by the above-described exemplary embodiments, but should be defined only in accordance with the following claims and their equivalents. Furthermore, while certain advantages of the invention have been described herein, it is to be understood that not necessarily all such advantages may be achieved in accordance with any particular embodiment of the invention. Thus, for example, those skilled in the art will recognize that the invention may be embodied or carried out in a manner that achieves or optimizes one advantage or group of advantages as taught herein without necessarily achieving other advantages as may be taught or suggested herein.

What is claimed is:

1. A stepper robot, comprising:
a first foot assembly including a first suction cup, a first vacuum generator, and a first valve, said first vacuum generator being operationally connected to said first suction cup;
a second foot assembly including a second suction cup, a second vacuum generator, and a second valve, said second vacuum generator being operationally connected to said second suction cup; and
a conduit to connect a source of operational fluid flow to said first and second vacuum generators, said first valve positioned to control fluid flow to said first vacuum generator and said second valve positioned to control fluid flow to said second vacuum generator;
wherein the robot is a low profile robot having a total height of 5 inches or less.

2. The stepper robot of claim 1, further comprising:
a base coupled to said first and second foot assemblies; and
a first actuator interconnecting said base and said first foot assembly;
wherein said first actuator is a linear actuator configured to translate said first foot assembly relative to said base.

3. The stepper robot of claim 2, wherein said first actuator is also a rotational actuator configured to rotate said first foot assembly relative to said base.

4. The stepper robot of claim 2, further comprising a second actuator interconnecting said base and said first foot assembly, wherein said second actuator is a rotational actuator configured to rotate said first foot assembly relative to said base.

5. The stepper robot of claim 2, further comprising:
a second actuator interconnecting said base and said first foot assembly; wherein:
said first actuator is a linear actuator configured to translate said first foot assembly substantially parallel relative to said base; and
said second actuator is a linear actuator configured to translate said first foot assembly substantially perpendicularly relative to said base.

6. The stepper robot of claim 5, further comprising a third actuator interconnecting said base and said first foot assembly, wherein said third actuator is a rotational actuator configured to rotate said first foot assembly relative to said base.

7. The stepper robot of claim 6, further comprising a fourth actuator interconnecting said base and said second foot assembly, wherein said fourth actuator is a linear actuator configured to translate said second foot assembly substantially perpendicularly relative to said base.

8. The stepper robot of claim 6, further comprising a fourth actuator interconnecting said base and said second foot assembly, wherein said fourth actuator is a rotational actuator configured to rotate said second foot relative to said base.

9. The stepper robot of claim 1, wherein the robot has a total height of 3 inches or less.

10. The stepper robot of claim 1, wherein the robot has an overall footprint of 1 ft² or less.

11. The stepper robot of claim 1, wherein:
said first foot assembly further includes a first pressure sensor to detect the presence of a vacuum in said first suction cup; and
said second foot assembly further includes a second pressure sensor to detect the presence of a vacuum in said second suction cup.

12. The stepper robot of claim 1, wherein:
said first foot assembly further includes a third suction cup spaced from said first suction cup and operationally coupled to said first vacuum generator; and
said second foot assembly further includes a fourth suction cup spaced from said second suction cup and operationally coupled to said second vacuum generator.

13. A method of inspecting a body having an outer surface, comprising:
providing a low profile stepper robot, said stepper robot including:
a base;
a first foot assembly coupled to said base, said first foot assembly including a first suction cup, a first vacuum generator, and a first valve, said first vacuum generator being operationally connected to said first suction cup;
a second foot assembly coupled to said base, said second foot assembly including a second suction cup, a second vacuum generator, and a second valve, said second vacuum generator being operationally connected to said second suction cup;
a conduit to connect a source of operational fluid flow to said first and second vacuum generators, said first valve positioned to control fluid flow to said first vacuum generator and said second valve positioned to control fluid flow to said second vacuum generator;
a first actuator interconnecting said base and said first foot assembly, said first actuator being a linear actuator configured to translate said first foot assembly relative to said base; and
an inspection sensor;
positioning said stepper robot on the surface;
engaging the source to provide operational fluid flow to said first and second vacuum generators; and
moving said stepper robot over the surface by engaging and disengaging said first valve, said second valve, and said first actuator.

14. The method of claim 13, wherein:
said providing further includes providing said stepper robot including a second actuator interconnecting said base and said first foot assembly, said second actuator being a rotational actuator configured to rotate said first foot assembly relative to said base; and
said moving further includes engaging and disengaging said second actuator.

15. The method of claim 14, wherein:
said providing further includes providing said stepper robot including a third actuator interconnecting said base and said first foot assembly, said third actuator being a linear actuator configured to translate said first foot assembly substantially perpendicularly relative to said base and said first actuator being a configured to translate said first foot assembly substantially parallel relative to said base; and
said moving further includes engaging and disengaging said third actuator.

16. The method of claim 15, wherein:
said providing further includes providing said stepper robot including a fourth actuator interconnecting said base and said second foot assembly, said fourth actuator being a linear actuator configured to translate said second foot assembly substantially perpendicularly relative to said base; and
said moving further includes engaging and disengaging said fourth actuator.

17. The method of claim 13, wherein:
said providing further includes providing said stepper robot wherein:
said first foot assembly further includes a first pressure sensor to detect the presence of a vacuum in said first suction cup; and
said second foot assembly further includes a second pressure sensor to detect the presence of a vacuum in said second suction cup; and
said moving includes:
disengaging said first valve only if said second pressure sensor detects the presence of a vacuum in said second suction cup; and
disengaging said second valve only if said first pressure sensor detects the presence of a vacuum in said first suction cup.
